(19) United States
(12) Patent Application Publication
(10) Pub. No.: US 2025/0121874 A1
(43) Pub. Date: Apr. 17, 2025

(54) THRUST ROD ASSEMBLY FOR A LINEAR ACTUATOR, AND LINEAR ACTUATOR WITH A THRUST ROD ASSEMBLY

(71) Applicant: Schaeffler Technologies AG & Co. KG, Herzogenaurach (DE)

(72) Inventors: Sebastian Krueger, Fürth (DE); Holger Paetzold, Burgebrach (DE)

(73) Assignee: Schaeffler Technologies AG & Co. KG, Herzogenaurach (DE)

(21) Appl. No.: 18/696,024

(22) PCT Filed: Aug. 19, 2022
(86) PCT No.: PCT/DE2022/100617

§ 371 Date: Mar. 27, 2024

(30) Foreign Application Priority Data
Oct. 1, 2021 (DE) 10 2021 125 484.1

(51) Int. Cl. B62D 5/04

(52) U.S. Cl. CPC B62D 5/0445; B62D 5/0424

(57) ABSTRACT

The disclosure relates to a thrust rod assembly for a linear actuator of an axle steering system of a vehicle, having at least one first rod and a spindle for converting a rotational movement of a drive device into a linear movement of the thrust rod assembly. The spindle has a spindle shoulder and, at a first axial end, a first connector shoulder for connection to the first rod. Between the spindle shoulder and the first connector shoulder, the spindle has a first receiving shoulder with a securing element received fixedly thereon for conjoint rotation for providing an anti-rotation safeguard of the thrust rod assembly. The securing element is held in the axial direction between the spindle shoulder and the first rod.

### CROSS-REFERENCE TO RELATED APPLICATIONS

This application is the U.S. National Phase of PCT Application No. PCT/DE2022/100617 filed on Aug. 19, 2022, which claims priority to DE 10 2021 125 484.1 filed on Oct. 1, 2021, the entire disclosures of which are incorporated by reference herein.

### TECHNICAL FIELD

The disclosure relates to a thrust rod assembly for a linear actuator of an axle steering system of a vehicle.

### BACKGROUND

Generic thrust rod assemblies for linear actuators are known from the prior art. Such linear actuators are used, for example, in rear axle steering systems in motor vehicles for rear axle steering. In this context, it is common for a shoulder with a non-round geometry or radial projections to be formed on the rod as an anti-rotation safeguard, which interact(s) with a corresponding geometry on a housing of the linear actuator in order to secure the rod assembly against rotation.

EP 1 911 660 A1, for example, discloses a linear actuator with a thrust rod assembly comprising a spindle and a rod connected thereto, wherein an anti-rotation safeguard is formed on the rod, which holds the thrust rod assembly relative to a housing in the circumferential direction.

The disadvantage of such anti-rotation safeguards is that they are complex to manufacture, in particular as the anti-rotation safeguard must be firmly connected to the rod in the axial direction, for example by means of a material connection. Accordingly, such anti-rotation safeguards are expensive.

### SUMMARY

In view of the aforementioned prior art, it is the object of the present disclosure to propose a thrust rod assembly that is simple and inexpensive, as described herein.

A thrust rod assembly according to the disclosure is characterized in that the spindle has, between the spindle shoulder and the first connector shoulder, a receiving shoulder with a securing element received thereon in a non-rotatable manner for providing an anti-rotation safeguard of the thrust rod assembly, and the securing element is held in the axial direction between the spindle shoulder and the first rod.

For the purposes of the disclosure, the axial direction is to be understood as the longitudinal direction of the thrust rod assembly. In a motor vehicle in which a linear actuator with the thrust rod assembly is used for the axle steering system of the rear wheels, the longitudinal direction of the thrust rod assembly is a transverse direction of the motor vehicle.

The disclosure now comprises the teaching that a securing element independent of the first rod, i.e., manufactured as an individual part, is used for the anti-rotation safeguard, which is slid onto a shoulder of the spindle and held axially between the spindle and the first rod. Since the spindle is usually made of a different material than the first rod and a two-part design of the spindle and first rod is therefore necessary, the connection can be cleverly used by the disclosure in order to achieve axial securing of the securing element. It is therefore no longer necessary to form an anti-rotation safeguard on the first rod. The securing element is also independent of the first rod as an individual part and can therefore be easily manufactured. When assembling the thrust rod assembly, the securing element can also be easily slid onto the spindle via the first connector shoulder.

In particular, the securing element is held axially between the spindle and the first rod by virtue of the spindle shoulder and the first rod each having a larger outer radius than the receiving shoulder and thus projecting radially beyond the securing element. Insofar as the spindle, the receiving shoulder and/or first rod do not have a round geometry at the joints between them, a radial projection is to be understood as the spindle and the first rod projecting radially beyond the securing element at least over part of the circumference, in particular in sections.

The thrust rod assembly can also have a second rod, which is connected to the spindle via a second connector shoulder of the spindle. The second connector shoulder is then located at a second axial end of the spindle, which is opposite the first end.

In an example embodiment, the receiving shoulder has a non-round outer geometry and the securing element has a corresponding inner geometry for the non-rotatable connection of the receiving shoulder to the securing element. For example, the outer geometry is a polygon or a knurling. In this way, the securing element is held in a manner secured against rotation on the receiving shoulder and at the same time can be easily mounted by sliding it on axially.

In an example embodiment, the securing element has a non-round outer geometry. A corresponding mating geometry can then be provided on a housing of the linear actuator, in which the securing element is secured against rotation by its non-round geometry. Such a mating geometry can also serve as an axial guiding surface for the securing element when the thrust rod assembly is adjusted. The securing element can be made of or coated with a material with good sliding properties on contact surfaces that are intended to come into contact with such a guiding surface.

In an example embodiment, the securing element is formed in several parts from a radially inner retaining element and a radially outer sliding element connected to the retaining element in a non-rotatable manner. The retaining element is then intended to hold the securing element on the receiving shoulder and to transmit a force between the securing element and the receiving shoulder as part of the anti-rotation safeguard. In particular, the retaining element is made of a suitably strong material, such as metal. The sliding element is designed to slide along a guiding surface of a housing with as little friction as possible. In particular when a torsional load is applied to the thrust rod assembly, pressing occurs between the securing element and the guiding surface, which could prevent axial movement of the securing element if the friction is too high. The thrust rod assembly would then become stuck.

The retaining element can have a non-round outer geometry for the non-rotatable connection of the retaining element to the sliding element and the sliding element has a corresponding inner geometry in such an embodiment. In particular, this geometry involves knurling. The sliding element is then held securely on the retaining element.

In an example embodiment, the retaining element is held in the axial direction between the spindle shoulder and the first rod and the sliding element is held axially relative to the retaining element. A very large radial projection of the spindle shoulder and the first rod over the securing element is then not necessary. For axially holding the sliding element on the retaining element, the retaining element can have a projection extending in the radial direction and the sliding element has a corresponding recess or the sliding element has a projection extending in the radial direction and the retaining element has a corresponding recess. Such projections and recesses can interrupt a knurling, for example.

Alternatively, it is possible for the securing element to be made in one piece from a material that simultaneously has good strength properties and favorable friction properties. Alternatively, it is also possible for the securing element to be made of a solid material that is coated with a sliding coating on the contact surfaces.

In an example embodiment, the spindle has a thread on the first connector shoulder, wherein the first rod has a mating thread, and wherein the spindle is connected to the first rod by means of a screw connection of the thread to the mating thread. The securing element can then have an axial overhang over the receiving shoulder, so that the first rod presses the securing element against a flank of the spindle shoulder with an end face by means of the screw connection. In particular, the threads are designed in such a way that the screw connection is self-locking. The screw connection can also be additionally glued.

The securing element is then held axially in a particularly secure manner. Alternatively, other fastening means can also be provided between the spindle and the first rod, such as clamping means, bonding or an interference fit in which the parts are thermally joined.

The disclosure also relates to a linear actuator for an axle steering system of a vehicle with an axially movably mounted thrust rod assembly as described above, a drive device for axially adjusting the thrust rod assembly and with a transmission for converting a rotational movement of the drive device into a linear movement of the thrust rod assembly by means of the spindle and a spindle nut acting thereon. The linear actuator utilizes the aforementioned advantages of the thrust rod assembly as well as the thrust rod assembly or also has them.

The linear actuator can have a stationary housing and the housing has a guiding geometry for axially guiding the securing element, wherein the securing element is held on the guiding geometry in a non-rotatable manner.

A stationary arrangement of an element is understood to mean that this element is positioned and held independently of the movement of the thrust rod assembly, i.e., it does not move with the thrust rod assembly when it is adjusted or is influenced in its position by its movement. For example, such an element can be fixed to a housing of the linear actuator or to the underbody of a motor vehicle to which the linear actuator is attached.

The guiding geometry is formed in particular from a sliding material with a low coefficient of friction or is coated with such a material. POM or PTFE, for example, can be used as a sliding material for this application and for all other applications described above in which a material should have favorable friction properties.

### BRIEF DESCRIPTION OF THE DRAWINGS

Further measures to improve the disclosure are illustrated below together with the description of exemplary embodiments of the disclosure using the figures. In the figures:

FIG. 1 shows a simplified representation of a linear actuator,

FIG. 2 shows a thrust rod assembly according to the disclosure,

FIG. 3 shows an exploded view of a thrust rod assembly according to FIG. 2, and

FIG. 4 shows a spindle with a securing element arranged thereon.

### DETAILED DESCRIPTION

FIG. 1 shows a linear actuator 1 with a housing 2 in which a thrust rod assembly 7, not shown here, is guided. A drive device 3 acts on the thrust rod assembly 7, which is arranged parallel to the thrust rod assembly 7 and the drive power of which is transmitted to the thrust rod assembly 7 via a belt drive 4 in a belt housing. Forks 5.1, 5.2 are arranged at the ends of the thrust rod assembly 7, by means of which a linear movement of the thrust rod assembly 7 can be transmitted to the wheels of a vehicle. A sensor housing 6 is further arranged on the linear actuator 1.

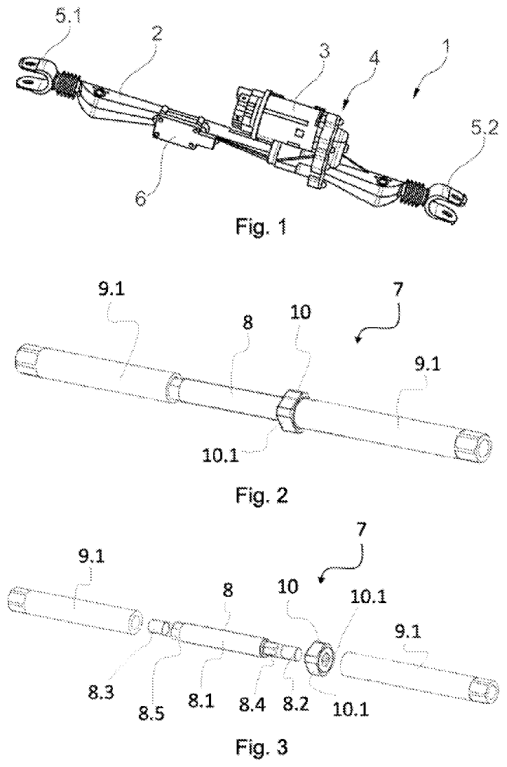

FIG. 2 shows a thrust rod assembly 7 with a centrally arranged spindle 8 and rods 9.1, 9.2 arranged at the ends of the spindle 8. A securing element 10 is arranged between the spindle 8 and a first rod 9.1, which is slid onto a receiving shoulder of the spindle 8. The securing element 10 has a non-round outer geometry 10.1, which is designed here as a quadrilateral geometry with cut-off corners. With the non-round geometry 10.1, the securing element 10 is axially guided on a mating geometry in the housing 2, which is not shown, and held in a manner secured against rotation.

FIG. 3 shows the thrust rod assembly 7 from FIG. 2 in an exploded view. The spindle 8 has a spindle shoulder 8.1, a first connector shoulder 8.2 and a second connector shoulder 8.3, wherein the connector shoulders 8.2, 8.3 each have external threads for connecting the spindle 8 to the rods 9.1, 9.2. A receiving shoulder 8.4 is provided between the spindle shoulder 8.1 and the first connector shoulder 8.2, onto which the securing element 10 is slid. The receiving shoulder 8.4 has a non-round geometry for this purpose, which interacts with a knurling 10.2 of the securing element 10, so that the securing element 10 is held on the receiving shoulder 8.4 in a manner secured against rotation. In this regard, the securing element 10 bears axially against the spindle shoulder 8.1, wherein the first rod 9.1 also bears axially against the securing element 10 when the rod assembly 7 is assembled, so that the securing element 10 is held axially between the spindle 8 and the first rod 9.1. The spindle 8 also has a tool shoulder 8.5, which is used to engage a tool when assembling the rod assembly 7 and has a corresponding tool geometry. The rods 9.1, 9.2 have shoulders with non-round geometries at the ends facing away from the spindle 8 for connecting the rods 9.1, 9.2 to the forks 5.1, 5.2 in a non-rotatable manner.

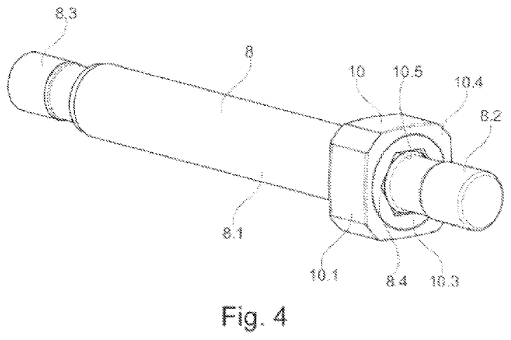

FIG. 4 shows the spindle 8 with a securing element 10 arranged thereon in detail, wherein the spindle 8 is shown here without a tool shoulder 8.5. The securing element 10 is formed from a radially inner retaining element 10.3 and a radially outer sliding element 10.4. The retaining element 10.3 is made of a high-strength material, so that there is a secure connection between the securing element 10 and the spindle 8. The sliding element 10.4 is formed from a material with favorable sliding properties, so that there is a low coefficient of friction between the securing element 10 and an axial guide in the housing 2. The retaining element 10.3 and the sliding element 10.4 are connected to one another in a non-rotatable manner via a knurling. It is further not shown that the knurling between the retaining element 10.3 and the sliding element 10.4 is interrupted in the axial direction by at least one radially extending tongue-and-groove connection, which in particular extends around the entire circumference of the lateral surfaces of the retaining element 10.3 and the sliding element 10.4. The retaining element 10.3 and the sliding element 10.4 are held together in the axial direction by the tongue-and-groove connection. The spindle shoulder 8.1 and the first rod 9.1 then only hold the retaining element 10.3 in the axial direction. In contrast to FIG. 3, the securing element 10 is designed here with a hexagonal geometry 10.5 on its inner lateral surface instead of a knurling 10.2, by means of which it is held on the receiving shoulder 8.4 in a manner secured against rotation.

### LIST OF REFERENCE SYMBOLS

1 Linear actuator
2 Housing
3 Drive device
4 Belt drive
5.1 Fork
5.2 Fork
6 Sensor housing
7 Thrust rod assembly
8 Spindle
8.1 Spindle shoulder
8.2 First connector shoulder
8.3 Second connector shoulder
8.4 Receiving shoulder
8.5 Tool shoulder
9.1 First rod
9.2 Second rod
10 Securing element
10.1 Non-round geometry of the securing element
10.2 Knurling of the securing element
10.3 Retaining element of the securing element
10.4 Sliding element of the securing element
10.5 Hexagonal geometry

1. A thrust rod assembly for a linear actuator of an axle steering system of a vehicle, the thrust rod assembly comprising:
a first rod, and
a spindle configured for converting a rotational movement of a drive device into a linear movement of the thrust rod assembly, the spindle comprising:
a spindle shoulder having:
a first axial end having a first connector shoulder configured to be fixed to the first rod,
a securing element configured to provide anti-rotation of the thrust rod assembly, and
a receiving shoulder configured to non-rotatably receive the securing element, the securing element axially fixed between the spindle shoulder and the first rod.

2. The thrust rod assembly according to claim 1,
wherein the receiving shoulder has a non-round outer geometry and the securing element has a corresponding inner geometry so as to define a non-rotatable connection between the receiving shoulder and the securing element.

3. The thrust rod assembly according to claim 2, wherein the securing element has a non-round outer geometry.

4. The thrust rod assembly according to claim 3, wherein the securing element comprises a radially inner retaining element and a radially outer sliding element non-rotatably connected to the retaining element.

5. The thrust rod assembly according to claim 4, wherein the retaining element has a non-round outer geometry and the sliding element has a corresponding inner geometry so as to define a non-rotatable connection between the retaining element and the sliding element.

6. The thrust rod assembly according to claim 5, wherein the retaining element is axially fixed between the spindle shoulder and the first rod, and the sliding element axially fixed to the retaining element.

7. The thrust rod assembly according to claim 6, wherein the retaining element includes a first projection extending in a radial direction and the sliding element has a corresponding recess configured to receive the first projection, or the sliding element includes a second projection extending in the radial direction and the retaining element includes a corresponding recess configured to receive the second projection.

8. The thrust rod assembly according to claim 2, wherein:
the spindle further comprises a thread arranged on the first connector shoulder,
the first rod further comprises a mating thread, and
the spindle is connected to the first rod via a screw connection of the thread to the mating thread.

9. A linear actuator for an axle steering system of a vehicle comprising an axially movably mounted thrust rod assembly according to claim 2, the linear actuator comprising:
a drive device for axially adjusting the thrust rod assembly, and
a transmission for converting a rotational movement of the drive device into a linear movement of the thrust rod assembly the spindle and a spindle nut acting thereon.

10. The linear actuator according to claim 9, wherein:
the linear actuator includes a stationary housing,
the housing has a guiding geometry for axially and non-rotatably guiding the securing element.

11. The thrust rod assembly according to claim 1, wherein the receiving shoulder is offset from the first axial end of the spindle shoulder.

12. The thrust rod assembly according to claim 2, further comprising:
a second rod, and
a second connector shoulder arranged at a second axial end of the spindle shoulder for connection to the spindle.

13. The thrust rod assembly according to claim 12, wherein:
the spindle further comprises a first thread arranged on the first connector shoulder and a second thread arranged on the second connector shoulder,
the first rod further comprises a first mating thread,
the second rod further comprises a second mating thread, and
the spindle is connected to the first rod via a first screw connection of the first thread and the first mating thread, and
the spindle is connected to the second rod via a second screw connection of the second thread and the second mating thread.

14. A thrust rod assembly for a linear actuator of an axle steering system of a vehicle, the thrust rod assembly comprising:
a first rod, and
a spindle configured for converting a rotational movement of a drive device into a linear movement of the thrust rod assembly, the spindle comprising:
a spindle shoulder having:
a first axial end having a first connector shoulder configured to be fixed to the first rod,
a receiving shoulder, and
a securing element:
disposed on the receiving shoulder,
non-rotatably fixed to the spindle shoulder,
having a non-round outer geometry configured to provide anti-rotation of the thrust rod assembly, and
axially fixed to the spindle shoulder via the first rod.

15. The thrust rod assembly according to claim 14, wherein the securing element is axially fixed to the spindle shoulder via a screw connection formed between the first connector shoulder and the first rod.

16. The thrust rod assembly according to claim 14, wherein the first connector shoulder extends away from the securing element in an axial direction.

17. The thrust rod assembly according to claim 14, wherein the receiving shoulder has a non-round geometry so as to form a non-rotatable connection with the securing element.

18. The thrust rod assembly according to claim 17, wherein the non-round geometry of the receiving shoulder and a knurling of the security element define a non-rotatable connection between the receiving shoulder and the security element.

19. A method of installing a securing element to a thrust rod assembly of a linear actuator for a steering system of a vehicle, the method comprising:
providing a linear actuator configured to convert rotary motion to linear motion of the thrust rod assembly, the thrust rod assembly comprising a spindle,
sliding a security element on a first axial end of the spindle such that the security element non-rotatably engages a receiving shoulder of the spindle, the security element configured to provide anti-rotation of the thrust rod assembly via an outer geometry of the security element,
attaching a first rod to the first axial end of the spindle so as to axially fix the security element to the spindle.

20. The method according to claim 19, wherein the thrust rod assembly further comprises:
a first rod threadably attached to the first axial end of the spindle so as to axially fix the security element to the spindle, and
a second rod threadably attached to a second axial end of the spindle.
